(19) United States
(12) Patent Application Publication
(10) Pub. No.: US 2025/0023036 A1
(43) Pub. Date: Jan. 16, 2025

(54) NEGATIVE ELECTRODE MATERIAL FOR LITHIUM BATTERY AND LITHIUM ION SECONDARY BATTERY COMPRISING SAME

(71) Applicant: MURATA MANUFACTURING CO., LTD., Kyoto (JP)

(72) Inventors: Yan ZHOU, Shanghai (CN); Li WANG, Shanghai (CN); Yuli LI, Shanghai (CN)

(21) Appl. No.: 18/904,542

(22) Filed: Oct. 2, 2024

Related U.S. Application Data
(63) Continuation of application No. PCT/CN2023/078540, filed on Feb. 27, 2023.

(30) Foreign Application Priority Data
May 6, 2022 (CN) 2022104871449

(51) Int. Cl. H01M 4/48; C01B 33/113; H01M 4/02; H01M 4/13; H01M 4/36; H01M 4/62; H01M 10/0525

(52) U.S. Cl. CPC H01M 4/483; C01B 33/113; H01M 4/13; H01M 4/366; H01M 4/625; H01M 10/0525; C01P 2002/02; C01P 2002/72; C01P 2002/74; C01P 2004/51; C01P 2006/40; C01P 2006/62; C01P 2006/63; C01P 2006/64; H01M 2004/027

(57) ABSTRACT

A negative electrode material for a lithium battery and a lithium ion secondary battery including same are provided. The negative electrode material for a lithium battery includes a silicon monoxide satisfying, in terms of chromaticity, 30≤L≤50, 3≤a≤10, and 1.5≤b≤10, and preferably 35≤L≤45, 4≤a≤9, and 4≤b≤10, and having a total color difference ΔE of 39≤ΔE≤50 relative to black.

### CROSS REFERENCE TO RELATED APPLICATIONS

The present application is a continuation of PCT patent application no. PCT/CN2023/078540, filed on Feb. 27, 2023, which claims priority to Chinese patent application no. 2022104871449, filed on May 6, 2022, the entire contents of which are incorporated herein by reference.

### BACKGROUND

The present application relates to the field of lithium ion secondary batteries, and in particular, to a negative electrode material for a lithium battery and a lithium ion secondary battery comprising same.

In recent years, with the continuous update of electronic technologies, the demand for battery devices for energy supply of electronic devices has also been increasing. Today, batteries capable of storing more energy and outputting high power are needed. Conventional lead-acid batteries, nickel-hydrogen batteries, and the like have been unable to meet the needs of new electronic products. Therefore, lithium batteries have attracted wide attention. In the development of lithium batteries, the capacity and performance thereof have been improved effectively.

In order to improve the energy density of a battery, a silicon monoxide material is considered to be a negative electrode material most suitable for commercialization at present. However, silicon monoxide per se has the problems of low initial efficiency and poor cycle performance. In order to solve these problems, the current mainstream practice is to use silicon monoxide as a raw material and coat same with carbon. However, in many cases, the performance of a carbon-coated silicon monoxide cannot be improved due to inappropriate selection of raw materials. Therefore, there is still a need in the art for a silicon monoxide material that exhibits good electrochemical properties and is suitable for carbon coating.

### SUMMARY

In an embodiment, the present application provides a silicon monoxide material. The silicon monoxide material has good capacity and cycle performance by itself, can be used in combination with carbon nanotubes as an electrode active material, and can also be used as a raw material for a carbon-coated silicon monoxide according to an embodiment.

In an embodiment, the present application provides a negative electrode material for a lithium battery, comprising a silicon monoxide, wherein the silicon monoxide satisfies, in terms of chromaticity, 30≤L≤50, 3≤a≤10, and 1.5≤b≤10, and preferably 35≤L≤45, 4≤a≤9, and 4≤b≤10, and having a total color difference ΔE of 39≤ΔE≤50 relative to black.

Further, in the negative electrode material in an embodiment, the particle size distribution of the silicon monoxide satisfies 0.5≤(D90−D10)/D50≤2, and preferably 0.9≤(D90−D10)/D50≤1.4.

Further, in the negative electrode material in an embodiment, the particle size distribution of the silicon monoxide satisfies that the number of particles having a particle size of less than 2 μm accounts for 3%-40%, and preferably 10%-30%, of the total number of particles.

Further, in the negative electrode material in an embodiment, the silicon monoxide is in an amorphous state or a low crystalline state.

Further, in the negative electrode material in an embodiment, when the silicon monoxide is in a low crystalline state, the size of crystalline silicon in the silicon monoxide is less than 4 nm, and preferably less than 1 nm.

Further, in the negative electrode material in an embodiment, the silicon monoxide may contain or may not contain crystalline silicon dioxide.

Further, in the negative electrode material in an embodiment, when the silicon monoxide comprises crystalline silicon dioxide, in the XRD pattern of the silicon monoxide, the ratio of the strongest peak intensity h₁ at 2θ of 26-27° to the strongest peak intensity h₂ at 2θ of 22.5-24° satisfies h₂/h₁<1.5, and preferably ≤1.3.

Further, in the negative electrode material in an embodiment, in a capacity-voltage differential curve of a half cell made of the negative electrode material measured with a current of 0.05 C according to an initial lithium intercalation curve, the first peak appears at 0.25 V-0.43 V, and preferably 0.36 V-0.43 V.

Further, in the negative electrode material in an embodiment, the negative electrode material further comprises carbon nanotubes.

According to another embodiment of the present application, provided is a negative electrode material for a lithium battery, comprising a carbon-coated silicon monoxide, wherein the silicon monoxide is the silicon monoxide in the described aspects of the present application.

According to still another embodiment of the present application, provided is a lithium ion secondary battery, comprising a positive electrode plate, a negative electrode plate, a separator and an electrolyte, wherein the negative electrode plate comprises the negative electrode material in each of the above aspects of the present application.

By means of the negative electrode material for a lithium battery and the lithium ion secondary battery comprising same in the present application, in an embodiment, the effect of improving the electrochemical properties of the lithium ion secondary battery is achieved.

### DETAILED DESCRIPTION

It is to be noted that embodiments in the present application and features in the embodiments can be combined with one another. The present application will be described in further detail below with reference to embodiments.

As explained in the background, although silicon monoxide has been used in a negative electrode active material for a lithium battery in the prior art, there is no clear guideline on how to select a specific silicon monoxide that has good electrochemical properties and is suitable for carbon coating. The present inventors have conducted research on the problem of improving the performance of the silicon monoxide, and found that the performance of the silicon monoxide is associated with aspects such as chromaticity, particle size distribution and crystal structure of the silicon monoxide material. As a result of research, the present application provides, in an embodiment, a silicon monoxide negative electrode material for a lithium battery, which has good electrochemical properties by itself, and therefore can be used in combination with carbon nanotubes as an electrode active material, and can also be used as a raw material for a carbon-coated silicon monoxide.

According to an embodiment of the present application, provided is a negative electrode material for a lithium battery, comprising a silicon monoxide. The silicon monoxide satisfies, in terms of chromaticity, 30≤L≤50, 3≤a≤10, and 1.5≤b≤10, and preferably 35≤L≤45, 4≤a≤9, and 4≤b≤10, and has a total color difference ΔE of 39≤ΔE≤50 relative to black.

The present inventors have found that by selecting a silicon monoxide having a specific chromaticity, a silicon monoxide negative electrode material for a lithium battery having good electrochemical properties can be obtained. For example, the present inventors have found that a silicon monoxide material having a colorimetric value within the range defined by the present application has good capacity, efficiency, and cycle performance, and these performances increase as the chromaticity increases within the scope of the present application. On the other hand, when the colorimetric value is excessively low or high, the initial capacity, efficiency, and cycle performance of the silicon monoxide material deteriorate.

Chromaticity of the silicon monoxide material is determined by factors such as the quality of the silicon monoxide raw material (e.g. the purity of silicon and silicon dioxide raw materials for preparing the silicon monoxide), particle size, and purity (e.g. the content of impurities such as Fe and Cu). Although the relationship between the chromaticity of the silicon monoxide material and the structure of the material is still under research, now it has been determined that the chromaticity of the material is higher when there are more fine particles in the silicon monoxide material. In addition, the presence form and content of metals in the raw material and the final powder of the silicon monoxide also affect the chromaticity of the material. For example, when Fe in a silicon monoxide material is present in the form of ferric oxide and the amount thereof is large, the chromaticity of the material will be low. Therefore, the chromaticity of the silicon monoxide material reflects the characteristics of the material in terms of structure and composition, and thus it can be inferred that there is a certain correlation between the chromaticity of the silicon monoxide material and the electrochemical properties of the material.

In addition, the present inventors also have found, for example, that the colorimetric value of the silicon monoxide material is also related to the position of the peak in the dQ/dV curve during the electrochemical reaction, the peak position of the material with a larger colorimetric value is generally larger, and the electrochemical properties of the battery with a larger peak position is relatively good.

In an embodiment of the present application, the particle size distribution of the silicon monoxide satisfies 0.5≤(D90−D10)/D50≤2, and preferably 0.9≤(D90−D10)/D50≤1.4.

In an embodiment of the present application, the particle size distribution of the silicon monoxide satisfies that the number of particles with a particle size of less than 2 μm accounts for 3%-40%, and preferably 10%-30% of the total number of particles.

In an embodiment of the present application, the silicon monoxide is in an amorphous or low crystalline state. When the silicon monoxide is in a low crystalline state, the size of crystalline silicon in the silicon monoxide is less than 4 nm, and preferably less than 1 nm.

In an embodiment of the present application, the silicon monoxide comprises or is free of silicon dioxide. When the silicon monoxide comprises crystalline silicon dioxide, in the XRD pattern of the silicon monoxide, the ratio of the strongest peak intensity h₁ at 2θ of 26-27° to the strongest peak intensity h₂ at 2θ of 22.5-24° satisfies h₂/h₁<1.5, and preferably ≤1.3.

The present inventors have found that the particle size distribution and crystal structure of the silicon monoxide material are also related to the properties of the material. For example, the particle size distribution parameter (D90−D10)/D50 of the material reflects the width of the particle size distribution. A larger value represents a wider particle size distribution. The proportion of the number of particles with a particle size of less than 2 μm reflects the number of fine particles in the material. The inventors have found that, within the range of the present application, when the particle size distribution is relatively wide, it is beneficial to improve the processability of electrode material slurry. In addition, fine particles in the material can be filled between large particles to improve the compaction density and rate performance of an electrode plate. Furthermore, during the electrochemical reaction, small particles have less volume expansion effect, which contributes to improve the cycle performance of a battery.

On the other hand, the present inventors have found that if the (D90−D10)/D50 value is too large and the number of particles of less than 2 μm is too small, the cycle performance of the battery may deteriorate. If the (D90−D10)/D50 value is too small and the number of particles of less than 2 μm is too large, the battery capacity may be reduced.

In addition, the present inventors have found that the presence of crystalline silicon and silicon dioxide crystal in the silicon monoxide material also affects the performance of the material. For example, similar to what described above, when the size of crystalline silicon in the material is too large, there are adverse effects on the volume expansion, the cycle performance, and the like of the battery. In the XRD pattern of the silicon monoxide, the ratio of the strongest peak intensity h₁ at 2θ of 26-27° to the strongest peak intensity h₂ at 2θ of 22.5-24° reflects the crystalline silicon dioxide content in the silicon monoxide material. A higher value represents a higher content of crystalline silicon dioxide. The presence of a small amount of crystalline silicon dioxide in the silicon monoxide material can improve the cycle performance, but excessive amount of crystalline silicon dioxide will result in deterioration of the capacity and efficiency of the battery.

In an embodiment of the present application, in a capacity-voltage differential curve of a half cell made of the negative electrode material measured with a current of 0.05 C according to an initial lithium intercalation curve, the first peak appears at 0.25 V-0.43 V, and preferably 0.36 V-0.43 V within a voltage range of 0-0.5 V.

As described above, the present inventors have found that the colorimetric value of the silicon monoxide material also have a relationship with the peak position in the dQ/dV curve during the electrochemical reaction, and the material having the peak position within the range of the present application has relatively good electrochemical properties. The difference of the position of the lithium intercalation peak is mainly due to the difference of the internal phase and structure of the material caused by the preparation process of the silicon monoxide material. It should be understood that, since the silicon monoxide material mainly has an amorphous structure, the direct relationship between the position of the lithium intercalation peak and the structure of the material has not been explained in the prior art, but the relationship between the lithium intercalation peak and the performance of the battery can be characterized experimentally.

According to another embodiment of the present application, the silicon monoxide of the present application may be used in combination with carbon nanotubes as an electrode active material for a lithium battery, and may also be used for preparing carbon-coated silicon monoxide as an electrode active material for a lithium battery.

The present inventors have found that when the silicon monoxide material of the present application was used as an active material in combination with an appropriate amount of carbon nanotubes, side reactions with an electrolyte can be reduced, the probability of lithium evolution and the expansion rate of sheets of a battery are reduced, the discharge capacity, rate performance and cycle performance of the lithium battery are improved, and the battery costs are reduced. The silicon monoxide material of the present application can improve the initial capacity and cycle performance of the carbon-coated silicon monoxide when using a raw material of the carbon-coated silicon monoxide.

According to another embodiment of the present application, a lithium ion secondary battery is provided. The lithium ion secondary battery comprises a positive electrode plate, a negative electrode plate, a separator, and an electrolyte, wherein the negative electrode plate comprises the silicon monoxide material in each of the described aspects of the present application.

The present application, in an embodiment, will be further described in detail in conjunction with the following specific examples, and these embodiments should not be construed as limiting the scope of protection of the present application.

### Example

Lithium ion batteries used in Examples were prepared by the following procedure.

### Preparation of a Silicon Monoxide Material:

A silicon powder with a certain particle size and silicon dioxide were mixed in a certain molar ratio. The mixture was placed on a vibrator and vibrated for 12 h until mixed uniformly. About 1 kg of the uniformly mixed powder was taken and pressed into a block. Then, the block was placed on a vacuum sublimation furnace and heated to a required temperature. A required bulk silicon monoxide precursor was prepared by adjusting the degree of vacuum, the heating time and the temperature at collection end, etc. The collected bulk silicon monoxide precursor was placed in a crusher for crushing to a millimeter level, and then the millimeter-level powder was placed in a jet mill for pulverizing. Powders with different particle sizes were sorted by an airflow classifier. Finally, the powders with different particle sizes were blended to obtain a powder with a specific particle size.

The preparation process and parameters for the silicon monoxide material used in the following examples of the present application are shown in Table 1.

TABLE 1
Preparation process and parameters for silicon monoxide materials used in the examples

| | Raw materials | | | | | | | | | | | |
|---|---|---|---|---|---|---|---|---|---|---|---|---|
| | Si | | SiO₂ | | Preparation process and parameters | | | | | | | |
| | | Particle | | Particle | | | | Collection | Powder crushing parameters | | | |
| | Molar | size | Molar | size | Vacuum | Heating | Heating | end | Feeding | Crushing | Feeding | |
| | amount | (D50, | amount | (D50, | degree | temperature | time | temperature | pressure | pressure | speed | Crushing |
| Example | (mol) | μm) | (mol) | μm) | (Pa) | (° C.) | (h) | (° C.) | (MPa) | (MPa) | (HZ) | atmosphere |
| Example | 1.1 | 15 | 1 | 40 | 30 | 1250 | 8 | 650 | 0.8 | 0.8 | 35 | Ar |
| 1 | | | | | | | | | | | | |
| Example | 1.05 | 25 | 1 | 40 | 10 | 1300 | 8 | 600 | 0.8 | 0.9 | 30 | Air |
| 2 | | | | | | | | | | | | |
| Example | 1.1 | 25 | 1 | 30 | 10 | 1350 | 8 | 650 | 0.8 | 0.8 | 30 | Ar |
| 3 | | | | | | | | | | | | |
| Example | 1.1 | 25 | 1 | 40 | 30 | 1400 | 10 | 950 | 0.9 | 0.9 | 29 | Ar |
| 4 | | | | | | | | | | | | |
| Example | 1.1 | 25 | 1 | 40 | 10 | 1350 | 8 | 700 | 0.5 | 0.5 | 50 | Air |
| 5 | | | | | | | | | | | | |
| Example | 1.1 | 25 | 1 | 40 | 30 | 1350 | 8 | 800 | 0.9 | 0.9 | 20 | Air |
| 6 | | | | | | | | | | | | |
| Example | 1.05 | 25 | 1 | 40 | 10 | 1350 | 8 | 600 | 0.8 | 0.8 | 40 | Ar |
| 7 | | | | | | | | | | | | |
| Example | 1.1 | 15 | 1 | 40 | 10 | 1300 | 10 | 550 | 0.8 | 0.7 | 30 | Ar |
| 8 | | | | | | | | | | | | |
| Example | 1.1 | 25 | 1 | 40 | 50 | 1400 | 7 | 800 | 0.8 | 0.7 | 42 | Ar |
| 9 | | | | | | | | | | | | |
| Example | 1.05 | 25 | 1 | 40 | 10 | 1350 | 8 | 600 | 0.8 | 0.9 | 35 | Ar |
| 10 | | | | | | | | | | | | |

### Preparation of a Negative Electrode Plate:

The negative electrode plate can be prepared according to a conventional method in the art. The silicon monoxide material or the carbon-coated silicon monoxide material, a conductive agent (such as conductive carbon black, conductive graphite, a vapor grown carbon fiber, carbon nanotubes, or any combination thereof), and a binder (such as one or more of styrene butadiene rubber (SBR), polyacrylic acid (PAA), and polyimide (PI) binders, and preferably, PAA binder) were dispersed in solvent water to form a uniform negative electrode slurry. The negative electrode slurry was coated on a negative electrode current collector, and dried to obtain a negative electrode plate.

For the specific negative electrode plates used in the Examples 1-10 hereinafter, the silicon monoxide material, a conductive agent Super-P (conductive carbon black) and a PAA binder at a mass ratio of 82:8:10 were sufficiently stirred and mixed in an appropriate amount of deionized water. A uniform negative electrode slurry was formed by adjusting the solid content. Then, the negative electrode slurry was coated on the surface of a negative electrode current collector copper foil, and dried to obtain the negative electrode plate.

In addition, for Examples 11 and 12 hereinafter, the silicon monoxide prepared in Examples 3 and 9, a conductive agent Super-P, carbon nanotubes and a PAA binder were mixed and stirred at a mass ratio of 80:9.9:0.1:10, respectively. An appropriate amount of deionized water was added to adjust the solid content so as to form a uniform negative electrode slurry. Then, the negative electrode slurry was coated on the surface of a negative electrode current collector copper foil, and dried to obtain a negative electrode plate. For Examples 13 and 14 hereinafter, the silicon monoxide prepared in Examples 3 and 9 were coated with carbon, the carbon-coated silicon monoxide, a conductive agent Super-P, carbon nanotubes and a PAA binder were mixed and stirred at a mass ratio of 80:9.9:0.1:10, an appropriate amount of deionized water was added to adjust the solid content so as to form a uniform negative electrode slurry, and then the negative electrode slurry was coated on the surface of a negative electrode current collector copper foil, and dried to obtain a negative electrode plate.

### Battery Assembly:

The prepared negative electrode plate, a separator, a lithium plate, a gasket and a battery shell were successively stacked, 100 ml of an electrolyte was injected, and sealing was performed by means of a sealing machine to form a negative electrode half cell.

### Test Methods

The various parameters of the silicon monoxide material and the electrochemical properties of the fabricated battery were tested by the following methods.

### (1) Measurement of the Colorimetric Value:

A suitable amount of the silicon monoxide sample was taken and placed in a sample cup, and a colorimetric test was performed using a spectrophotometer (Hangzhou CHNSpec, Model CS800), so as to obtain colorimetric values L, a and b, wherein L represents black and white, a represents red and green, and b represents yellow and blue. The color difference ΔE was calculated on basis of black by the following formula:

$$Δ E = {( {L}^{2} + {a}^{2} + {b}^{2} )}^{1 / 2}$$

### (2) Measurement of the Crystalline Silicon Size:

A suitable amount of the silicon monoxide sample was taken and embedded with a resin. Then, an ultrathin slicer was used to perform slicing. The cut slices were subjected to multiple silicon grain size measurements using TEM (Thermo Fisher Scientific, TALOS F200X), and the measured values were averaged. It should be noted that for samples with silicon grains <1 μm, as a very small amount of crystal is present inside the samples, a specific numerical value of the size cannot be determined, and therefore the value is shown as <1 μm.

(3) Determination of Peak Intensity Ratio h₂/h₁:

A suitable amount of the silicon monoxide powder sample was loaded onto a sample stage. A glass slide was used to flatten and compress the surface of the powder sample, and excess powder was scraped away. The prepared sample was then placed in an XRD apparatus (Bruker, Model D8) for testing. Test conditions are: test range 10°-80°, step 0.02°/min, scan speed: 1°/min. In the obtained XRD spectrum, the strongest peak intensity h₁ at 26°-27° and the strongest peak intensity h₂ at 22.5°-24° were read, and h₂/h₁ was calculated.

(4) Determination of the Lithium Intercalation Peak in a dQ/dV Curve:

The negative electrode half cell was charged/discharged at a current of 0.05 C, capacity and voltage data were recorded, and then differential was performed on the capacity and the voltage to obtain a dQ/dV curve. The first peak position occurred in the 0-0.5 V lithium intercalation stage was read on the dQ/dV curve.

(5) Measurement of the Number of Particles with a Particle Diameter of Less than 2 μm:

A suitable amount of the silicon monoxide powder sample was placed in water comprising a dispersant, stirred until dispersed, and then tested by using a laser particle size analyzer. The number of particles with a particle diameter of less than 2 μm was counted based on the number distribution.

### (6) Measurement of the Battery Capacity:

In an environment of 25° C., the initial capacity and initial efficiency as well as the 2nd cycle capacity and efficiency of the negative electrode half cell were obtained by cycling the negative electrode half cell twice by using a charge/discharge rate of 0.1 C and a charge/discharge voltage range of 0 V-1.5 V.

### (7) Measurement of the Battery Cycle Performance:

The battery after the capacity test was charged at a current of 0.1 C, then a charge-discharge cycle test was performed using the current of 1 C, and the capacity retention rate of the battery after 100 cycles was tested. The charge/discharge cut-off voltage was 0 V to 1.5 V.

### Test Results

Silicon monoxide negative electrode materials and negative electrode half cells were prepared using the methods and parameters described in the examples. The prepared silicon monoxide materials were tested for material parameters according to the test methods described above, and the prepared half cells were subjected to capacity and cycle tests according to the test methods described above. The test results are shown in Tables 2 and 3 below.

TABLE 2
Parameters of silicon monoxide materials and battery performance in Examples 1-10

| | | | | | | | | | | Electrochemical | |
|---|---|---|---|---|---|---|---|---|---|---|---|
| | | | | | | | | | | properties | |
| | | | | | Particle size | | | | | | Capacity |
| | | | | | distribution | | TEM | | dQ/dV | | retention |
| | | | | | (D90 − | Proportion | Crystalline | | First | Initial | rate (%) |
| | colorimetric value | | | | D10)/ | of particles | silicon | XRD | peak | capacity | after 100 |
| Example | L | a | b | Δ E | D50 | <2 μm | Size (nm) | h₂/h₁ | position | (mAh/g) | cycles |
| 1 | 44.41 | 8.57 | 9.67 | 46.26 | 1.20 | 13% | <1 | 0 | 0.39 | 1600 | 66 |
| 2 | 40.63 | 5.29 | 4.19 | 41.19 | 1.30 | 25% | <1 | 1.1 | 0.41 | 1626 | 65 |
| 3 | 40.06 | 5.20 | 4.10 | 40.61 | 1.2 | 23% | <1 | 0 | 0.43 | 1650 | 68 |
| 4 | 40.60 | 5.40 | 4.81 | 41.24 | 1.40 | 30% | 4 | 0 | 0.4 | 1460 | 57 |
| 5 | 38.84 | 4.14 | 2.14 | 39.12 | 0.80 | 0 | <1 | 1.2 | 0.34 | 1526 | 20 |
| 6 | 41.29 | 5.36 | 4.78 | 41.91 | 1.60 | 33% | <1 | 1.5 | 0.34 | 1543 | 40 |
| 7 | 39.10 | 4.90 | 2.81 | 39.50 | 1.00 | 5% | <1 | 0 | 0.36 | 1580 | 30 |
| 8 | 47 | 11.5 | 13.8 | 50.3 | 1.1 | 10% | <1 | 0 | 0.38 | 1560 | 60 |
| 9 | 38.24 | 3.45 | 2.04 | 38.45 | 0.90 | 3% | <1 | 0 | 0.25 | 1465 | 18 |
| 10 | 39.2 | 5 | 2.9 | 39.6 | 2.1 | 7.5% | <1 | 0 | 0.35 | 1590 | 35 |

TABLE 3
Parameters of silicon monoxide materials and battery performance in Examples 11-14

| | | | | | | | | | | Electrochemical | |
|---|---|---|---|---|---|---|---|---|---|---|---|
| | | | | | | | | | | properties | |
| | | | | | Particle size | | | | | | Capacity |
| | | | | | distribution | | TEM | | dQ/dV | | retention |
| | | | | | (D90 − | Proportion | Crystalline | | First | Initial | rate (%) |
| | colorimetric value | | | | D10)/ | of particles | silicon | XRD | peak | capacity | after 100 |
| Example | L | a | b | Δ E | D50 | <2 μm | size (nm) | h₂/h₁ | position | (mAh/g) | cycles |
| 11 | 40.06 | 5.20 | 4.10 | 40.61 | 1.2 | 23% | <1 | 0 | 0.43 | 1700 | 87 |
| 12 | 38.24 | 3.45 | 2.04 | 38.45 | 0.90 | 3% | <1 | 0 | 0.25 | 1520 | 48 |
| 13 | 40.06 | 5.20 | 4.10 | 40.61 | 1.2 | 23% | <1 | 0 | 0.43 | 1680 | 82 |
| 14 | 38.24 | 3.45 | 2.04 | 38.45 | 0.90 | 3% | <1 | 0 | 0.25 | 1500 | 30 |

As can be determined from the results of Table 2, the silicon monoxide materials of the present application (Examples 1-3) exhibit the best performance in terms of initial capacity and cycle performance. The results demonstrate that the silicon monoxide materials provided by the present application have good capacity and cycle performance.

With regard to the influence of the colorimetric values of the silicon monoxide materials on the performance, it can be determined from the comparison between Examples 1-3 and Examples 8-10 that the silicon monoxide material having colorimetric values of 30≤L≤50, 3≤a≤10, and 1.5≤b≤10, in particular 35≤L≤45, 4≤a≤9, and 4≤b≤10, and a total color difference ΔE of 39≤ΔE≤50 relative to black exhibits better electrochemical properties.

With regard to the effect of the particle size distribution of the silicon monoxide materials on the performance, it can be determined from the comparison between Examples 1-3 and Example 5, 6 and 10 that the silicon monoxide material with a particle size distribution satisfying 0.5≤(D90−D10)/D50≤2, in particular 0.9≤(D90−D10)/D50≤1.4 shows better electrochemical properties. In addition, by comparing Examples 1-3 with Examples 5-7, it can be determined that silicon dioxide material having particle size distribution satisfying that the number of particles with a particle size of less than 2 μm accounts for 3%-40%, and in particular, 10%-30% of the total number of particles exhibits better electrochemical properties. For example, when the proportion of particles with a particle size of less than 2 μm is 5% (Example 7), the electrochemical properties are better than those when the proportion is 0 (Example 5), but lower than those when the proportion is 10%-30% (Examples 1-3). When the proportion is 33% (Example 6), the electrochemical properties are also better than those when the proportion is 0 but lower than those when the proportion is 10%-30%.

With regard to the influence of the size of crystalline silicon in the silicon monoxide materials on the performance, it can be determined by comparing Example 4 with other examples, especially Examples 1-3, that the silicon monoxide materials with a crystalline silicon size of less than 4 nm, preferably less than 1 nm, exhibit better electrochemical properties.

With regard to the influence of the crystalline silicon dioxide content in the silicon monoxide materials on the performance, it can be determined from the comparison between Example 6 and other examples, and particularly Examples 1-3, that silicon monoxide materials of which the ratio of the strongest peak intensity h₁ at 2θ of 26-27° to the strongest peak intensity h₂ at 2θ of 22.5-24° in the XRD spectrum satisfies h₂/h₁<1.5, and particularly ≤1.3 show better electrochemical properties.

Regarding the relation between the capacity-voltage differential curve of the silicon monoxide material and the performance, it can be determined by comparing Examples 1-3 with Example 9 and Examples 5, 6 and 10 that in a capacity-voltage differential curve of a half cell measured with a current of 0.05 C according to an initial lithium intercalation curve, in the voltage range of 0-0.5 V, when the first peak appears at 0.25V-0.43V, and particularly 0.36V-0.43V, the silicon monoxide material for preparing the half cell exhibits better electrochemical properties.

In addition, it can be determined from Examples 11 and 13 in Table 3 that the silicon monoxide material of the present application can be used in combination with carbon nanotubes, can also be used for forming a carbon-coated silicon monoxide, and has a more excellent initial capacity and capacity retention rate. However, silicon monoxide materials that do not meet the conditions defined in the present application (Examples 12 and 14) have poor initial capacity and capacity retention rate even after addition of carbon nanotubes or coating with carbon.

In conclusion, by selecting a silicon monoxide material having specific parameters according to the present application as a negative electrode material of a lithium ion battery, improvement in electrochemical properties of the battery is obtained as compared with a silicon monoxide material according to the related art.

The content above only relates to preferred examples of the present disclosure and is not intended to limit the present application. For a person skilled in the art, the present application may have various modifications and variations. Any modifications, equivalent replacements, improvements, etc. made within the spirit and principle of the present application shall all fall within the scope of protection of the present application.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A negative electrode material for a lithium battery, the negative electrode material comprising: a silicon monoxide, wherein the silicon monoxide satisfies, in terms of a chromaticity, 30≤L≤50, 3≤a≤10, and 1.5≤b≤10, and has a total color difference ΔE of 39≤ΔE≤50 relative to black.

2. The negative electrode material of claim 1, wherein the silicon monoxide satisfies, in terms of the chromaticity, 35≤L≤45, 4≤a≤9, and 4≤b≤10.

3. The negative electrode material of claim 1, wherein a particle size distribution of the silicon monoxide satisfies 0.5≤(D90−D10)/D50≤2.

4. The negative electrode material of claim 3, wherein the particle size distribution of the silicon monoxide satisfies preferably 0.9≤(D90−D10)/D50≤1.4.

5. The negative electrode material of claim 1, wherein a particle size distribution of the silicon monoxide satisfies that a number of particles having a particle size of less than 2 μm accounts for 3%-40%, of a total number of particles.

6. The negative electrode material of claim 5, wherein the number of particles having the particle size of less than 2 μm accounts for 10%-30%, of the total number of particles.

7. The negative electrode material of claim 1, wherein the silicon monoxide is in an amorphous state or a low crystalline state.

8. The negative electrode material of claim 7, wherein when the silicon monoxide is in a low crystalline state, the size of crystalline silicon in the silicon monoxide is less than 4 nm.

9. The negative electrode material of claim 7, wherein the silicon monoxide comprises a crystalline silicon dioxide or does not comprise the crystalline silicon dioxide.

10. The negative electrode material of claim 9, wherein when the silicon monoxide comprises the crystalline silicon dioxide, in the XRD pattern of the silicon monoxide, a ratio of the strongest peak intensity h₁ at 2θ of 26-27° to the strongest peak intensity h₂ at 2θ of 22.5-24° satisfies h₂/h₁<1.5.

11. The negative electrode material of claim 1, wherein in a capacity-voltage differential curve of a half cell made of the negative electrode material measured with a current of 0.05 C according to an initial lithium intercalation curve, the first peak appears at 0.25 V-0.43 V.

12. The negative electrode material of claim 1, wherein the negative electrode material further comprises carbon nanotubes.

13. A negative electrode material for a lithium battery, comprising a carbon-coated silicon monoxide, wherein the carbon-coated silicon monoxide includes the silicon monoxide according to claim 1.

14. A lithium ion secondary battery, comprising a positive electrode plate, a negative electrode plate, a separator and an electrolyte, wherein the negative electrode plate comprises the negative electrode material according to claim 1.
